(19) United States
(12) Patent Application Publication
(10) Pub. No.: US 2022/0199061 A1
(43) Pub. Date: Jun. 23, 2022

(54) ACOUSTIC CUBE

(71) Applicant: VICTOR ANDERSON, III, Redondo Beach, CA (US)

(72) Inventor: VICTOR ANDERSON, III, Redondo Beach, CA (US)

(21) Appl. No.: 17/129,617

(22) Filed: Dec. 21, 2020

(51) Int. Cl. G10K 11/162; G10K 11/172

(52) U.S. Cl. CPC G10K 11/162; G10K 11/172

(57) ABSTRACT

A movable, hollow cubical housing for enhancing the sound output of a mobile, wireless speaker. A plurality of apertures being provided in the side walls of the housing. The housing being provided with sound dampening material on the interior of the housing.

### FIELD OF INVENTION

The subject invention relates to the field of audio speaker enhancement devices and in particular moveable audio speaker enhancement devices

### BACKGROUND

It has long been known in the art to use portable speakers both outdoors and in indoor locations to enable individuals to have a speaker in close proximity without having to move the unit generating the sound, such as a stereo, computer, television set and the like. Modern speakers can communicate with the sound generating unit by means of wireless technology such as Bluetooth or others.

A problem or shortcoming with these standard portable speakers, when used outdoors, is that they can be exposed to the weather. Additionally, the sound quality in many instances is less than desired.

A need therefore exists for a portable unit which can hold a speaker and provide protection from the elements and at the same time enhance the quality of the sound emanating from the speaker.

It is an object of the subject invention to provide a housing for a wireless speaker that can be moved to locations remote from the sound generating unit wherein the design of the housing enhances the quality of the sound emanating from the speaker.

### SUMMARY OF THE INVENTION

The subject invention is comprised of a hollow cube shaped housing mounted on wheels. The top panel of the cube is mounted to the cube body by means of a hinge assembly that allows the top to be opened and closed.

Sound damping material is provided on the inside of the bottom panel of the housing and on the inside of the top panel. An opening is provided on each side panel of the housing with each opening being covered by a speaker cover.

### BRIEF DESCRIPTION OF THE DRAWINGS

FIG. 1 is a perspective view of the subject invention with the top open.

FIG. 2 is a top view of the subject invention with the top open.

FIG. 3 is a perspective view of the subject invention with the top closed.

FIG. 4 is a cross-sectional side view of the subject invention.

### DETAILED DESCRIPTION OF THE PREFERRED EMBODIMENTS

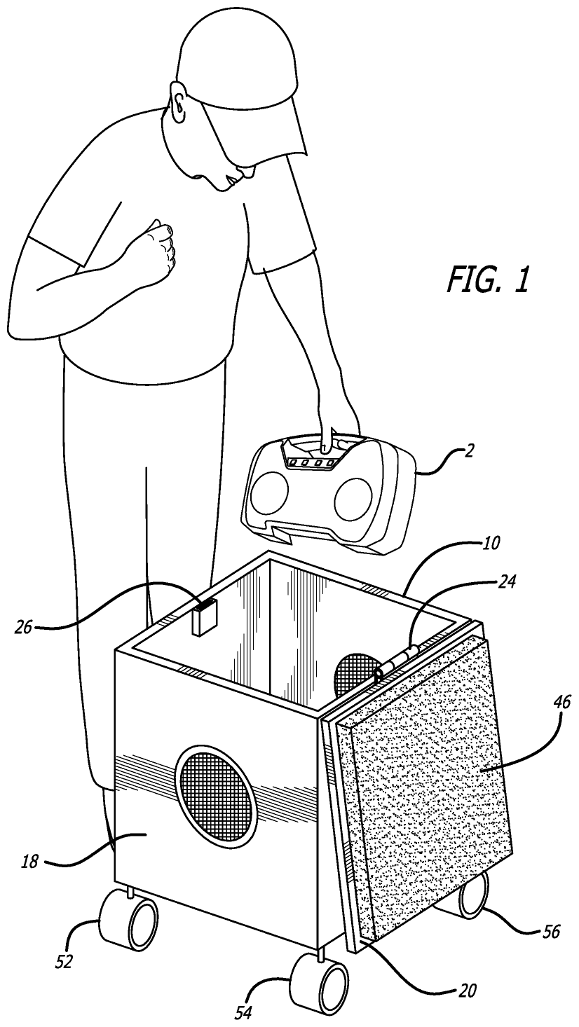

The acoustic cube 1 of the subject invention is shown in FIG. 1. The speaker housing 10 is shaped as a cube to allow for uniform reflection or vibration of the sound waves within the cube before the sound waves exit the cube.

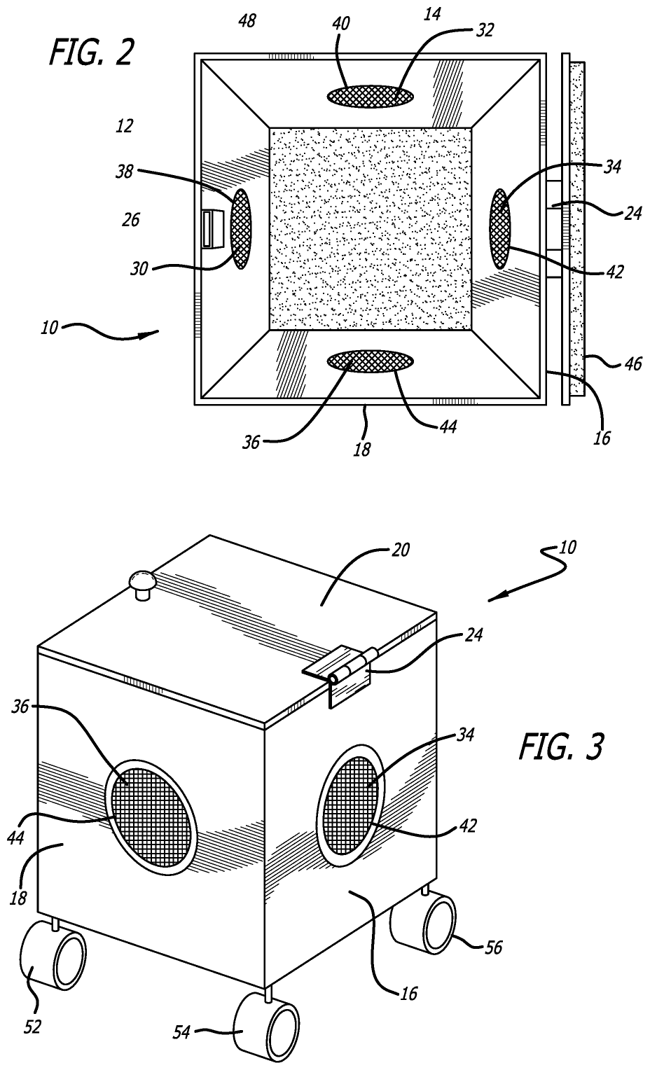

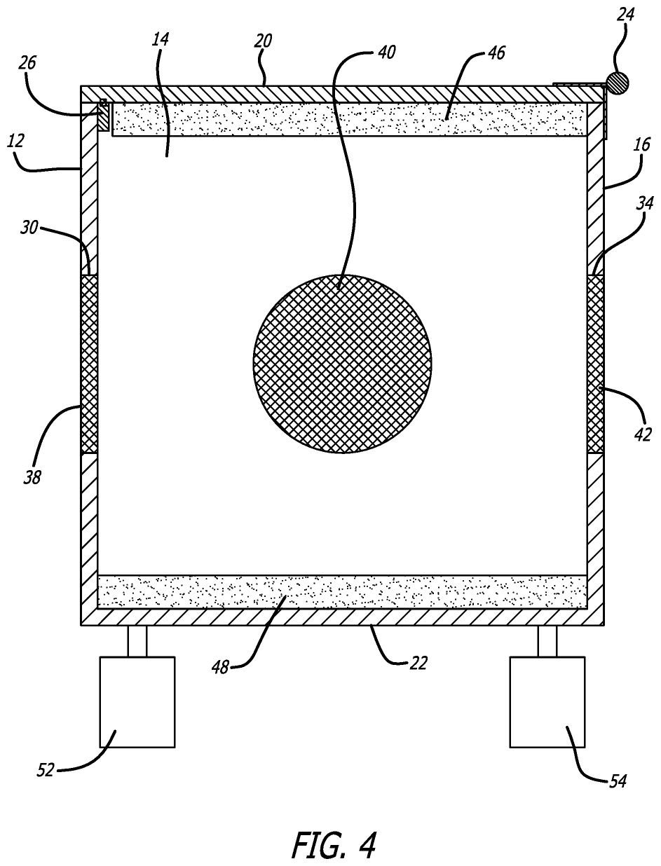

As shown in FIGS. 2 and 3 speaker housing 10 has four equal sized square side panels 12, 14, 16, 18 and equal sized square top and bottom panels 20 and 22.

Top panel 20 is pivotally mounted via a hinge assembly 24 to the upper end of side panel 16. A latch mechanism 26 is provided on the upper inside surface of opposing side panel 12 for holding the top panel 20 in a closed position. In a preferred embodiment, the latch mechanism may be a magnetic latch. Other latch mechanisms will be known to those skilled in the art.

Openings 30, 32, 34 and 36 are provided in side panels 12, 14, 16, 18, respectfully. Each of the openings is covered by a speaker cover or mesh assembly, 38, 40, 42, 44. The speaker covers serve to prevent debris or other items from entering the inside of the housing, while at the same time allowing the full sound of the speaker to exit the housing.

Dampening material 46, 48 is provided on the insider of both top and bottom panels of the housing. In a preferred embodiment, the dampening material may be foam rubber. Other dampening material will be known to those skilled in the art.

Most speakers fail to capture the full richness of instrumental and vocal music before releasing their sound waves into the ambient environment. The acoustic cube captures the sound and resonates it before releasing it into the ambient environment. This phenomena is what I call “Dynamic Sonic Resonance.” Placing a two-way or three-way speaker inside the acoustic cube will dynamically enrich the full range of musical sound.

As shown in FIGS. 1 and 3, the acoustic cube 1 is mounted on wheels 50, 52, 54, 56 which allow it to be easily rolled to whatever location the user wants. In a preferred embodiment the wheels are caster wheels.

In use one simply puts a wireless speaker 2 inside the housing 10 and closes the top panel 20 and wheels the acoustic cube to whatever location he or she wants limited only by the range of the speaker.

Although the invention has been shown and described with reference to certain preferred embodiments, those skilled in the art undoubtedly will find alternative embodiments obvious from reading this disclosure. With this in mind, the following claims are intended to define the scope of the invention and art not intended to be limited to the specific embodiments disclosed herein but rather are to be constructed to cover equivalent constructions which would be known to those skilled in the art.

I claim:

1. An acoustic cube comprising:
a housing having four equally sized square side walls each side wall having an outer and an inner surface, a square bottom panel and a matching square top panel having an outer and inner surface;
wherein the top panel is mounted via a hinge mechanism to the top of the housing;
a first sound dampening pad mounted on the inner surface of the top panel;
a second sound dampening pad mounted on the inner surface of the bottom panel; and
wherein an aperture is provided in each of the side panels of the housing and each of said apertures being covered by a mesh cover.

2. The acoustic cube of claim 1, wherein the housing is mounted upon a plurality of wheels.

3. The acoustic cube of claim 2, wherein the wheels are caster wheels.

4. The acoustic cube of claim 1, wherein a latch mechanism is provided for holding the top panel in a closed position.

5. The acoustic cube of claim 1, wherein the first and second sound dampening pads are foam rubber.
